(19) United States
(12) Patent Application Publication
(10) Pub. No.: US 2007/0143673 A1
(43) Pub. Date: Jun. 21, 2007

(54) Extensible architecture for chart styles and layouts

(75) Inventors: Kristin M. Tolle, Redmond, WA (US); Miltiadis Vafiadis, Bothell, WA (US); Stephen M. Heijster, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/313,001

(22) Filed: Dec. 20, 2005

(51) Int. Cl. G06F 17/00

(52) U.S. Cl. 715/530

(57) ABSTRACT

Various technologies and techniques are disclosed that enhance chart customization. As one non-limiting example, a chart style reader reads the settings associated with available chart styles from one or more style files. A chart layout reader reads the settings associated with available chart layouts from one or more layout files. The chart style and layout files can be custom-defined by a user, and/or can be system-defined (built-in). Menu options can be displayed in the user interface to allow a user to select a particular chart style and/or layout. When the user selects a particular chart style and/or layout, the settings stored in the file are applied to a chart in the document by a chart object renderer.

### BACKGROUND

There are various software programs that allow users to create charts, such as bar charts, pie charts, line charts, or scatter charts. Examples of such software programs that allow users to create charts include programs such as MICROSOFT® Office Excel, MICROSOFT® Office Word, and Lotus 1-2-3. The user must go through a series of steps to create a chart with a certain style and layout. This process can be very tedious and involve dozens of choices, even for the advanced user.

Furthermore, many organizations may have trademarked color schemes they use in their document creation. Some also have corporate standards for using particular layouts in association with data presentation objects, such as charts and diagrams. It is difficult for users to locate and apply these standard styles and/or layouts to their charts. This can frequently delay a user's charting work since they must go through this location and application process each time corporate standards change.

### SUMMARY

Described herein are various technologies and techniques that enhance chart customization. As one non-limiting example, a chart style reader reads the settings associated with available chart styles from one or more style files. A chart layout reader reads the settings associated with available chart layouts from one or more layout files. These style and layout files can be text files, such as extensible markup language (XML) files. The chart style and layout files can be custom-defined by a user, and/or can be system-defined (built-in). Menu options can be displayed in the user interface to allow a user to select a particular chart style and/or layout. When the user selects a particular chart style and/or layout, the settings stored in the file are applied to a chart in the document by a chart object renderer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of the business logic of a charting program operating on the computer system of FIG. 1 in one implementation.

FIG. 3 is a diagrammatic view of a charting program operating on the computer system of FIG. 1 in one implementation.

FIG. 4 is a high-level process flow diagram for one implementation of the system of FIG. 1.

FIG. 5 is a process flow diagram for one implementation of the system of FIG. 1 illustrating the stages involved in customizing a chart based on style and layout files.

FIG. 6 is a diagram for one implementation of the system of FIG. 1 illustrating a portion of the contents of an example XML layout file.

FIG. 7 is a simulated chart for one implementation of the system of FIG. 1 illustrating the layout settings in FIG. 6 applied to a particular chart.

FIG. 8 is a diagram for one implementation of the system of FIG. 1 illustrating a portion of the contents of an example XML style file.

FIG. 9 is a simulated chart for one implementation of the system of FIG. 1 illustrating the style settings in FIG. 8 applied to a particular chart.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that enhances the customization of charts, but the system also serves other purposes in addition to these. One or more of the techniques described herein can be implemented as features within a software program such as MICROSOFT® Office Excel, MICROSOFT® Office Word, Lotus 1-2-3, or from any other type of program or service that allows creation of charts.

As described in further detail herein, in one implementation of the system, a chart style reader reads the settings associated with available chart styles from one or more style files. A chart layout reader reads the settings associated with available chart layouts from one or more layout files. In one implementation, these style and layout files are text files, such as XML files. In another implementation, these style and layout settings are stored in a database. The chart style and layout files can be custom-defined by a user, and/or can be system-defined (built-in). When the user selects a particular chart style and/or layout from the user interface, the settings stored in the file are applied to a chart in the document by a chart object renderer.

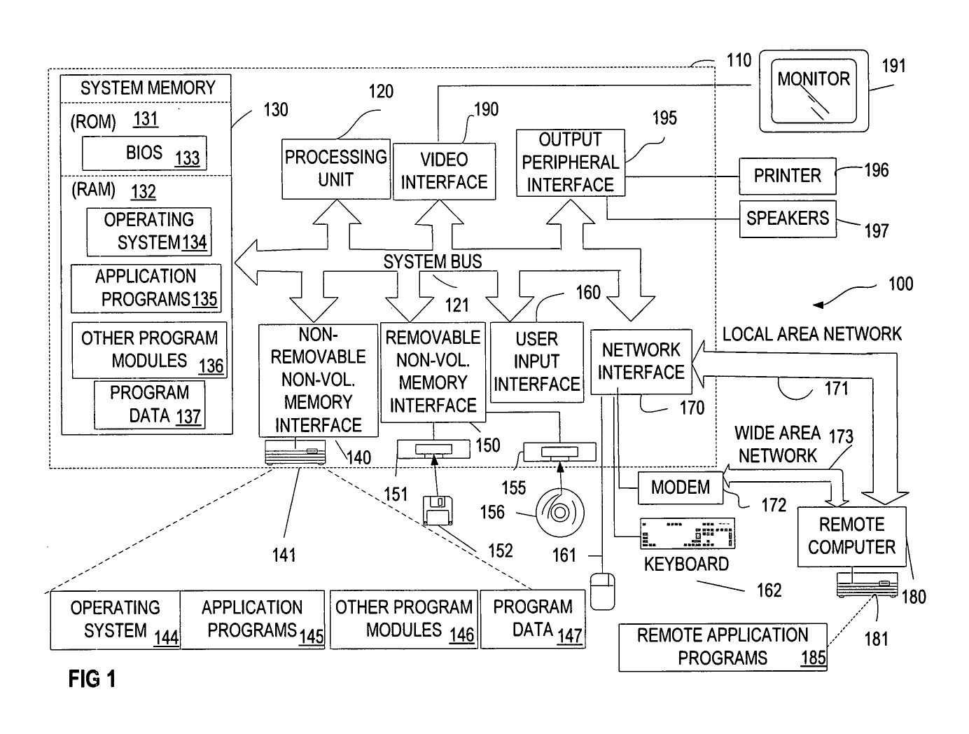

FIG. 1 illustrates an example of a suitable computing system environment 100 on which the system may be implemented. The computing system environment 100 is only one example of a suitable computing environment and is not intended to suggest any limitation as to the scope of use or functionality. Neither should the computing environment 100 be interpreted as having any dependency or requirement relating to any one or combination of components illustrated in the exemplary operating environment 100.

The system is operational with numerous other general purpose or special purpose computing system environments or configurations. Examples of well known computing systems, environments, and/or configurations that may be suitable for use with the system include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The system may be described in the general context of computer-executable instructions, such as program modules, being executed by a computer. Generally, program modules include routines, programs, objects, components, data structures, etc. that perform particular tasks or implement particular abstract data types. The system may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes. magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

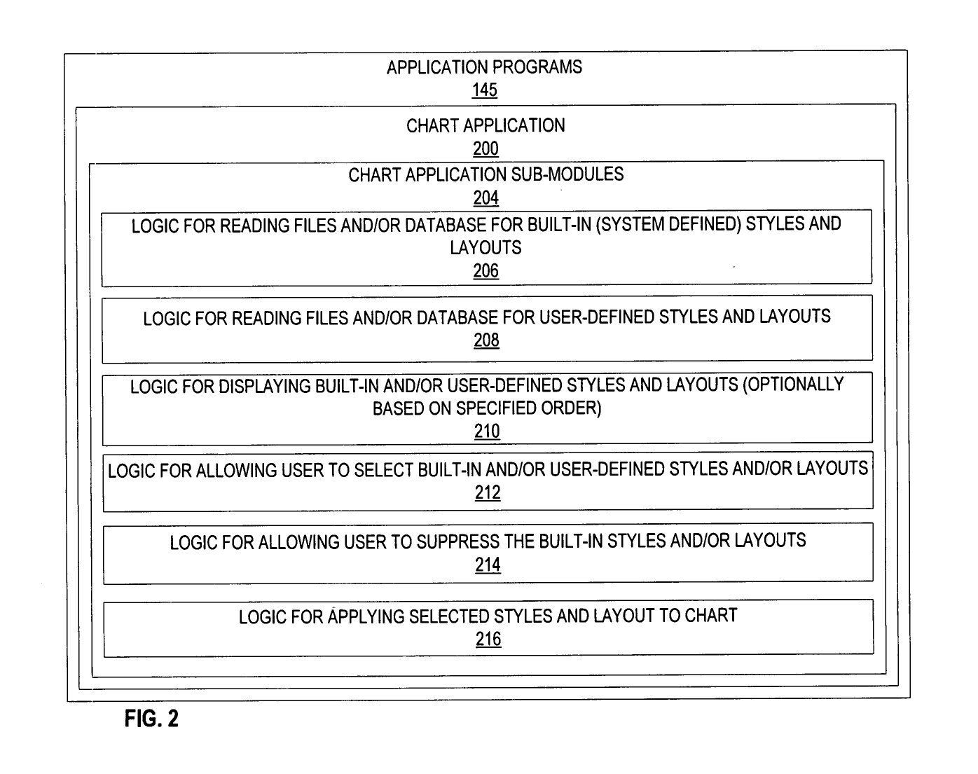

Turning now to FIG. 2 with continued reference to FIG. 1, charting application sub-modules 204 of a charting application 200 operating on computer 110 in one implementation is illustrated. In the example illustrated on FIG. 2, charting application 200 is one of application programs 145 that reside on computer 110. Alternatively or additionally, one or more parts of charting application 200 can be part of application programs 135 in RAM 132, on remote computer 181 with remote application programs 185, or other such variations as would occur to one in the computer software art.

Charting application 200 includes charting application sub-modules 204, which are responsible for carrying out some or all of the techniques described herein. Business logic includes logic for reading files and/or databases for built-in (system-defined) styles and layouts 206, logic for reading files and/or databases for user-defined styles and layouts 208, logic for displaying built-in and/or user-defined styles and layouts (optionally based on a specified order) 210, logic for allowing a user to select the built-in and/or user-defined styles and/or layouts 212, logic for allowing a user to suppress the built-in styles and/or layouts, and logic for applying the selected styles and layout to a chart 216. In one implementation, charting application sub-modules 204 are operable to be called programmatically from another program, such as using a single call to a procedure in charting application sub-modules 204. In FIGS. 1 and 2, charting application sub-modules 204 are shown to reside on computer 110 as part of application programs 145. However, it will be understood that charting application sub-modules 204 can alternatively or additionally be embodied as computer-executable instructions on one or more computers and/or in different variations than shown on FIG. 2. As one non-limiting example, one or more parts of charting application sub-modules 204 could alternatively or additionally be implemented as an XML web service that resides on an external computer that is called when needed.

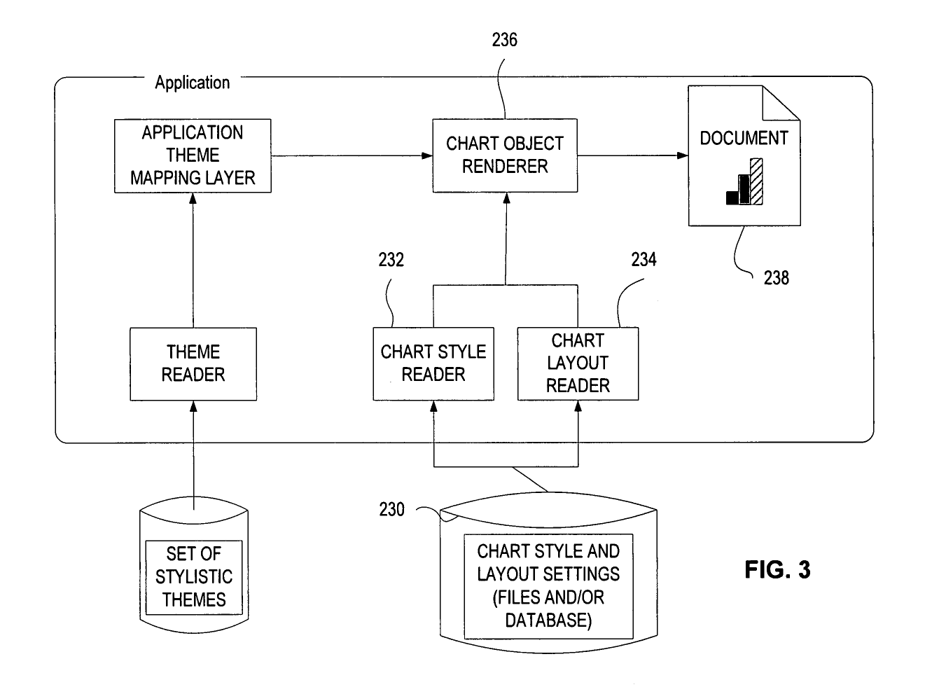

Turning now to FIG. 3 with continued reference to FIG. 1, a system diagram of charting program 200 of one implementation is shown. Chart style and layout settings 230 are stored in one or more files and/or databases on computer 110 and/or on remote computer 180. Chart style reader 232 and chart layout reader 234 are coupled to chart style and layout settings 230. Chart style reader 232 and chart layout reader 234 are also coupled to chart object renderer 236. Chart object renderer 236 is operable to create document 238 with particular chart style and layout settings 230. The operation of each of these will be described in further herein in the figures that follow.

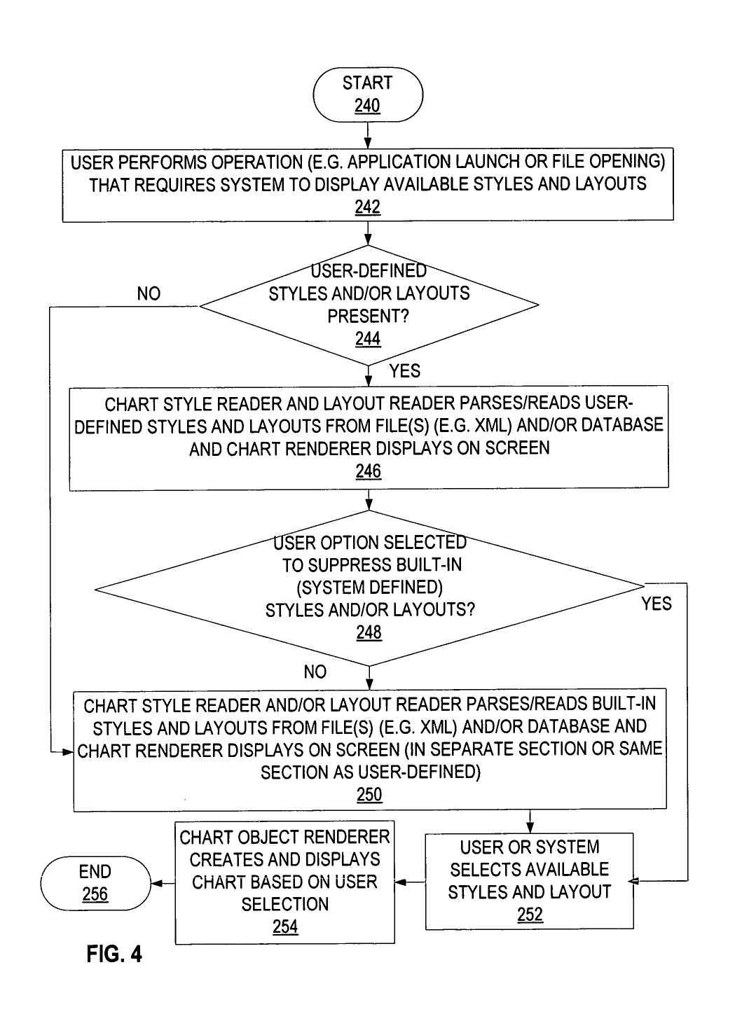

Turning now to FIGS. 4-9, with continued reference to FIGS. 1-3, process flow diagrams and simulated diagrams are used to describe the operation of charting application 200 in further detail. It will be appreciated that some, all, or fewer of these stages can be performed, and that they can be performed in a variety of different orders than as described in FIGS. 4-9. FIG. 4 is a high level process flow diagram of one implementation of charting application 200. In one form, the process of FIG. 4 is at least partially implemented in the operating logic of computing device 100 and is executed as part of charting application sub-modules 204.

The process begins at start point 240 with the user performing an operation that requires the system to display available styles and layouts (stage 242). One non-limiting example of such an operation is launching an application. Another non-limiting example of such an operation is opening a file. If user-defined styles and/or layouts are not present (decision point 242), the chart style reader 232 and chart layout reader 234 execute business logic 208 to parse and/or read the system-defined styles and layouts from files and/or database 230 for display as options on the screen (stage 250). If user-defined styles and/or layouts are present (decision point 244), such as in a specified file or directory, the chart style reader 232 and chart layout reader 234 execute business logic 208 to parse and/or read the user-defined styles and layouts from files and/or database 230 for displays as options on the screen (stage 246).

If the user selected an option to suppress the built-in, system-defined styles and/or layouts (decision point 248), the system-defined styles are not shown. If the option to suppress the system-defined styles and/or layouts has not been selected (decision point 248), the chart style reader 232 and chart layout reader 234 execute business logic 206 to parse and/or read the system-defined styles and layouts from files and/or database 230 for display as options on the screen (stage 250). In one implementation, the system-defined styles and/or layouts are displayed in a separate section of the screen than the user-defined styles and/or layouts. In another implementation, the system-defined styles and/or layouts are displayed in the same section of the screen as the user-defined styles and/or layouts. The user can select an available style and/or layout on the screen, or the system can select an available style and/or layout programmatically (stage 252). The chart object renderer 236 executes business logic 216 to create and display the chart based on the user's selection (stage 254).

As previously mentioned, in one implementation, these selection stages are implemented programmatically. One example of such programmatic implementation includes creating a custom program that includes a charting feature, and then calling charting application sub-modules 204 to use one or more aspects of the system in the custom program. In one implementation, the styles and/or layouts can be selected programmatically (stage 252), such as through automation, and applied (stage 254) programmatically to the chart by a single procedure call to charting application sub-modules 204. Multiple procedure calls could also be used. The process then ends at end point 256.

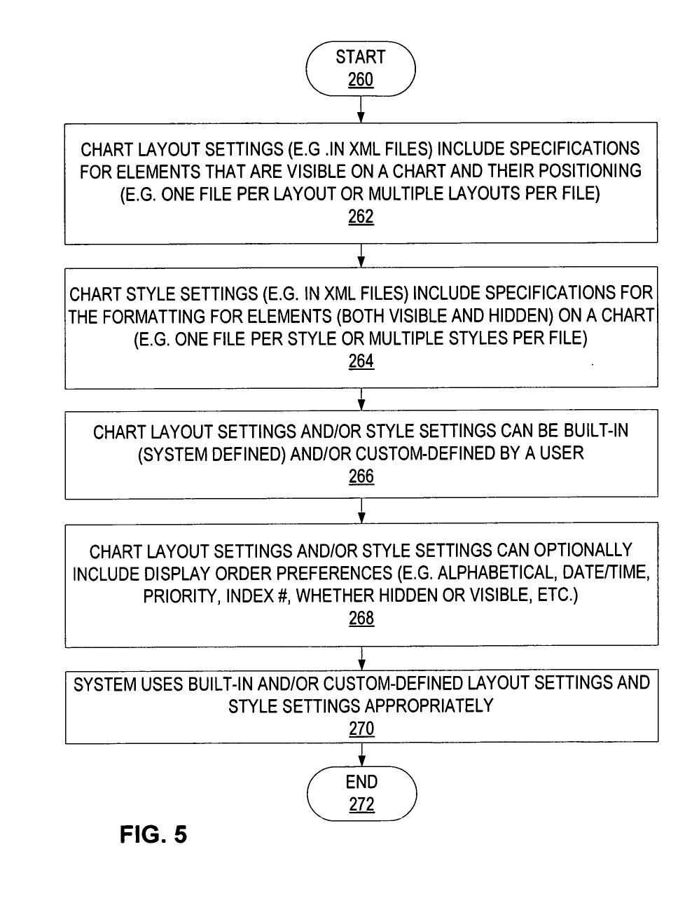

FIG. 5 illustrates the stages involved in customizing a chart based on style and layout files. One non-limiting example of the type of file that can be used for style and/or layout settings is a text file, such as one containing XML. Another non-limiting example of the type of file that can be used is one or more databases. In one form, the process of FIG. 5 is at least partially implemented in the operating logic of system 100. It will be appreciated that some, all, or fewer of the stages described in FIG. 5 can be performed, and they can be performed in a variety of different orders, including sequentially and/or parallel. The process begins at start point 260 with chart layout settings including specifications for all or some elements that are visible on a chart and their positioning (stage 262). In one implementation, each file contains only one layout. In another implementation, multiple layouts are contained in a single file. Chart style settings include specifications for the formatting of elements, such as every possible element, both visible and hidden (stage 264). In one implementation, each file only contains one style. In another implementation, multiple styles are contained in a single file.

Chart layout settings and/or style settings can be built-in, system-defined and/or they can be custom-defined by a user (stage 266). In one implementation, layout and/or style settings are custom-defined by a user to specify certain standard company or governmental layouts and/or styles. In another implementation, the user may use custom-defined styles as a way to capture their artistic flair. Chart layout settings and/or style settings can optionally include display order preferences to indicate the order they should be displayed in the user interface (stage 268). As a few non-limiting examples, the order preferences could indicate alphabetical order, date/time order, priority order, index number order, and/or whether the element should be hidden or visible. Other ordering and visibility preferences could also be used. Chart application 200 uses the built-in and/or custom defined layout settings and style settings appropriately (stage 270). The process then ends at end point 272.

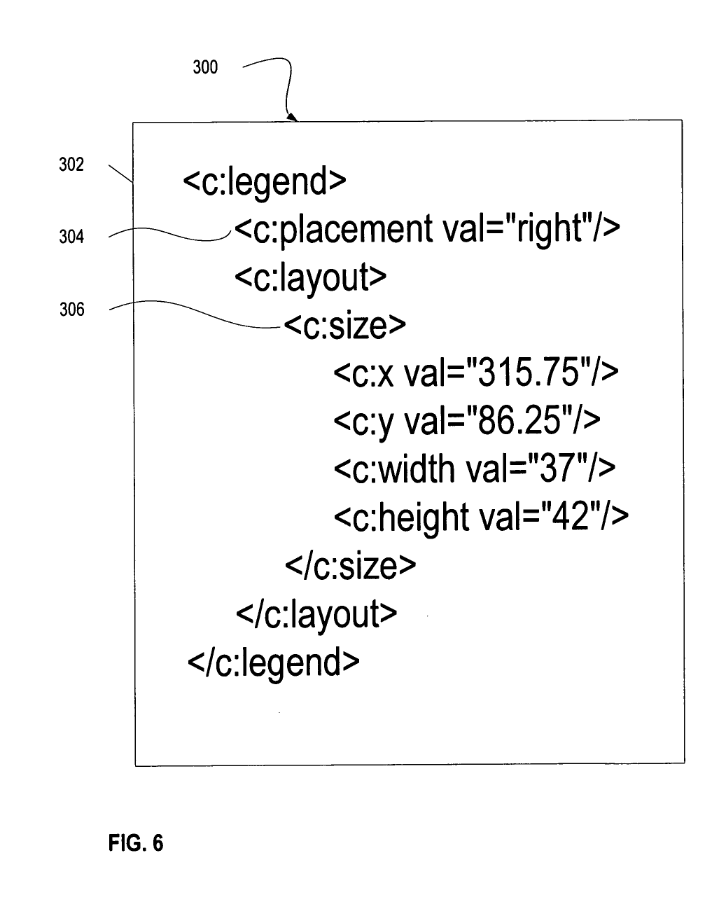

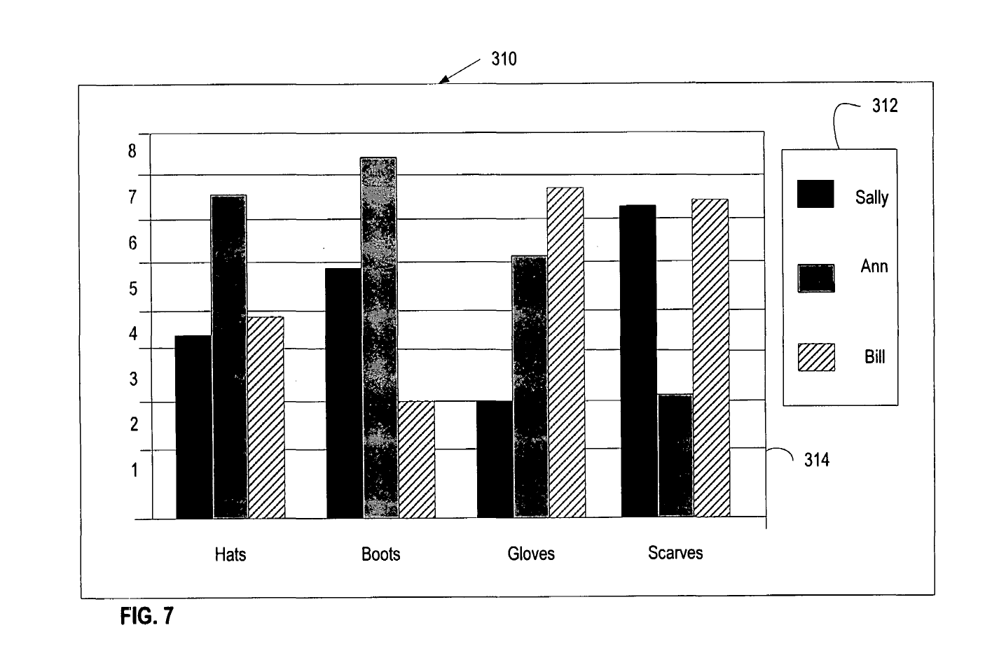

FIG. 6 is a diagram for one implementation of the system of FIG. 1 illustrating a portion of the contents of an example layout file 300 in an XML format. The file includes a legend tag 302 for specifying certain layout details about the legend element, such as legend placement 304 and legend size details 306. Legend placement details 304 indicate that the legend should be on the right. Legend size details 306 indicate the values, width, and height of the legend. FIG. 7 is a simulated chart 310 illustrating the layout settings in FIG. 6 applied to a particular chart. Legend 312 is shown to the right of the chart 314, and conforms to the size and other specifications described in file 300.

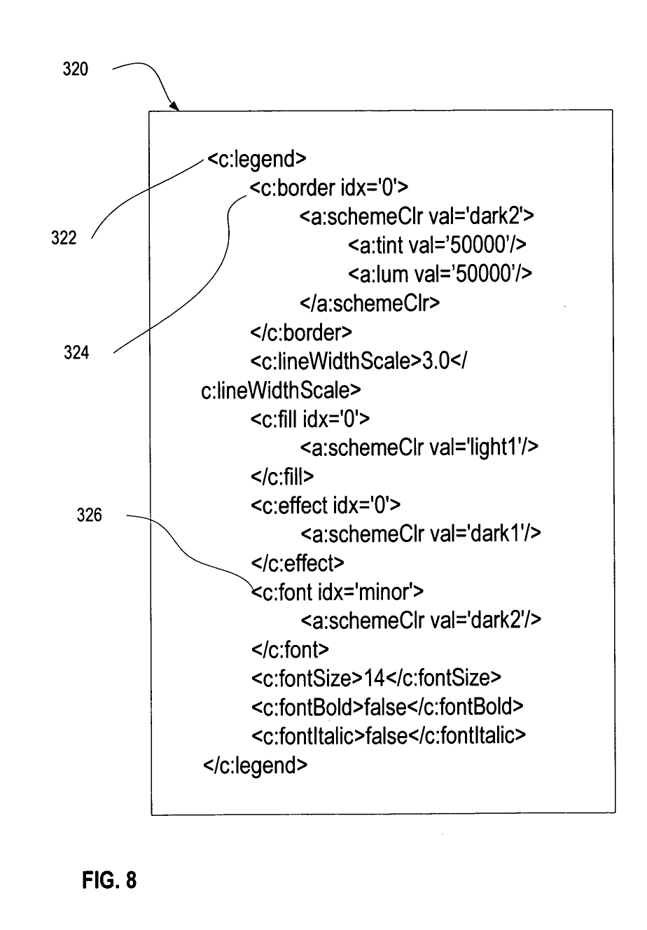

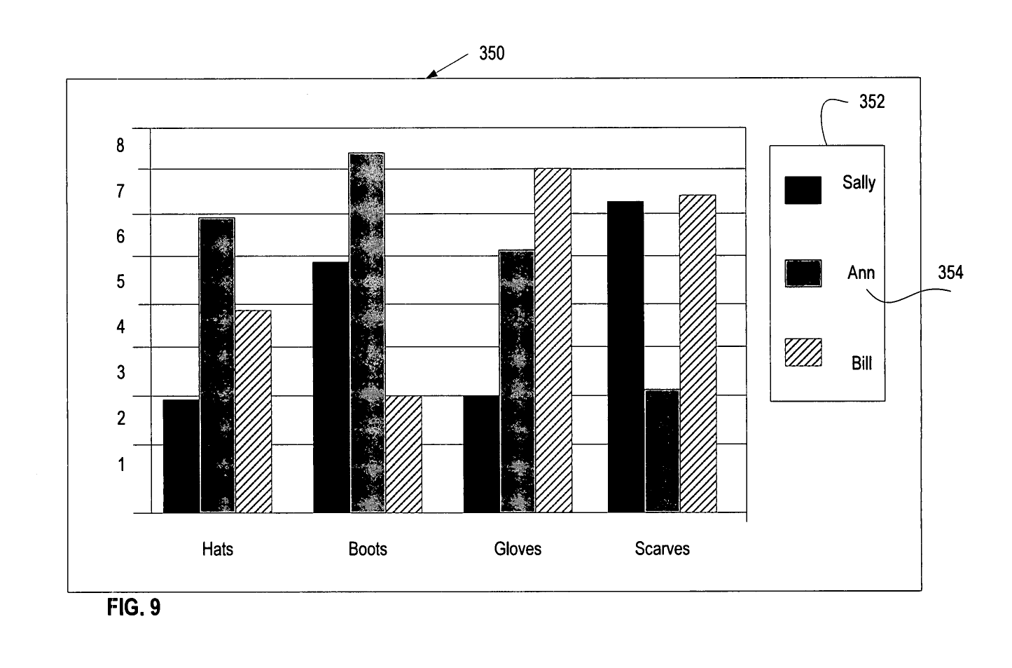

FIG. 8 is a diagram for one implementation of the system of FIG. 1 illustrating a portion of the contents of an example style file 320 in an XML format. The file includes a legend tag 322 for specifying certain style details about the legend element, such as legend border 324 and legend font 326. Legend border details 324 indicate that the legend should have a border with a certain tint and luminosity. Legend font details 326 indicate the font, font size, and other font details that should be used for the text in the legend. FIG. 9 is a simulated chart 350 illustrating the style settings in FIG. 8 applied to a particular chart. Legend 352 is shown with a border, and in the font size and other specifications described in file 320.

The simulated files 300 and 320 and their respective simulated charts 310 and 350 are illustrative in nature only. One will appreciate that other types of formats other than XML, and/or other than text files can be used for specifying layout and/or style settings for a chart. Furthermore, while the examples show styles in separate files from layouts, styles and layouts could be included together in one or more files. Furthermore, files may not be used alternate implementations. Databases and/or various other types of means for allowing a user and/or a system to specify and store layout and/or style settings for a chart could be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the system as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
reading a plurality of settings associated with at least one chart style from at least one style file;
reading a plurality of settings associated with at least one chart layout from at least one layout file;
displaying at least one style option corresponding to the at least one chart style, the style option being operable to be selected by a user;
displaying at least one layout option corresponding the at least one chart layout, the layout option being operable to be selected by the user;
in response to the user selecting a particular one of the at least one style option, applying the settings for the corresponding chart style to a chart in a document; and
in response to the user selecting a particular one of the at least one layout option, applying the settings for the corresponding chart layout to the chart in the document.

2. The computer-readable medium of claim 1, wherein the style file is a text file.

3. The computer-readable medium of claim 1, wherein the style file is an XML file.

4. The computer-readable medium of claim 1, wherein the layout file is a text file.

5. The computer-readable medium of claim 1, wherein the layout file is an XML file.

6. The computer-readable medium of claim 1, wherein the at least one style file includes a plurality of style files, each of the plurality of style files having settings for a particular corresponding style.

7. The computer-readable medium of claim 1, wherein the at least one layout file includes a plurality of layout files, each of the plurality of layout files having settings for a particular corresponding layout.

8. The computer-readable medium of claim 1, wherein the style file and layout file are a database.

9. The computer-readable medium of claim 1, wherein the at least one style file and the at least one layout file are the same file.

10. The computer-readable medium of claim 1, wherein the settings in the style file specify a plurality of elements that are visible on the chart and a positioning for each of the elements.

11. The computer-readable medium of claim 1, wherein the settings in the layout file specify a plurality of formatting settings for visible and hidden elements.

12. The computer-readable medium of claim 1, wherein the at least one chart style and the at least one chart layout are user-defined.

13. The computer-readable medium of claim 1, wherein the at least one chart style and the at least one chart layout are system-defined.

14. A method for enhancing chart customizations comprising the steps of:
reading a plurality of chart settings from a plurality of files, the chart settings being selected from the group consisting of chart layout settings and chart style settings;
displaying a plurality of chart options corresponding to the chart settings, the chart options being operable to be selected by a user; and
in response to the user selecting a particular one of the chart options, applying the chart settings for the corresponding chart option to a particular chart in a document.

15. The method of claim 14, wherein the plurality of files are XML files.

16. The method of claim 14, wherein at least a portion of the plurality of files were custom-defined by the user.

17. The method of claim 14, wherein at least a portion of the plurality of files were system-defined.

18. A computer-readable medium having computer-executable instructions for causing a computer to perform the steps recited in claim 14.

19. A system for enhancing chart customizations comprising:
a chart style reader operable to read a plurality of style settings from at least one style file;
a chart layout reader operable to read a plurality of layout settings from at least one layout file;
a chart object renderer operable to communicate with the chart style reader to apply at least a portion of the style settings to a particular chart upon selection from a user of a particular chart style; and
the chart object renderer being further operable to communicate with the chart layout reader to apply at least a portion of the layout settings to the particular chart upon selection from the user of a particular chart layout.

20. The system of claim 19, wherein the chart object renderer is further operable to communicate with a display device to display the particular chart to the user.
